(19) United States
(12) Patent Application Publication
(10) Pub. No.: US 2016/0082623 A1
(43) Pub. Date: Mar. 24, 2016

(54) SEPARATION DEVICE AND SEPARATION METHOD

(71) Applicant: DAIKI CO., LTD., Tokyo (JP)

(72) Inventors: Hiroshi ITO, Tokyo (JP); Junji YOSHINAGA, Tokyo (JP)

(73) Assignee: DAIKI CO., LTD., Tokyo (JP)

(21) Appl. No.: 14/957,006

(22) Filed: Dec. 2, 2015

Related U.S. Application Data
(63) Continuation of application No. PCT/JP2013/067219, filed on Jun. 24, 2013.

(51) Int. Cl. B29B 17/02; C08J 11/10

(52) U.S. Cl. CPC B29B 17/02; C08J 11/10; C08J 2323/06; C08J 2323/12; C08J 2367/03; B29B 2017/0255; B29B 2017/0268; B29L 2009/008

(57) ABSTRACT

Provided are a separation device and a separation method with which plastic and aluminum can be separated. A separation device includes a heating unit, a container, and a pressing member. The heating unit heats a processing target containing aluminum and one or more types of plastic to a first temperature. The first temperature is a temperature that is less than the melting point of aluminum and is greater than or equal to the melting point of at least one type of plastic. The container is for accommodating the processing target heated by the heating unit to the first temperature. The pressing member has a hole portion allowing the plastic melted by the heating unit to pass through, and separates aluminum and the plastic by pressing the processing target accommodated in the container.

### CROSS REFERENCE TO RELATED APPLICATION

This is a Continuation of International Application No. PCT/JP2013/067219 filed Jun. 24, 2013. The contents of this application are hereby incorporated by reference in their entirety.

### TECHNICAL FIELD

The present invention relates to a separation device and a separation method.

### BACKGROUND ART

In recent years, the need to recycle resources has been increasing, and among resources, it is important to recycle plastic. With regard to recycling of plastic, various techniques have been proposed (Patent Literature 1, for example).

### CITATION LIST

### Patent Literature

[PLT 1] JP 2008-156532A

### SUMMARY OF INVENTION

### Technical Problem

Incidentally, among plastics, there are plastics to which aluminum adheres, such as an aluminized film. In order to recycle such plastic, it is necessary to separate the plastic and the aluminum.

### Solution to Problem

The present invention has been made in view of the above-described issues, and an object thereof is to provide a separation device and a separation method with which plastic and aluminum can be separated.

A separation device according to the present invention includes a first heating means for heating a processing target containing aluminum and one or more types of plastic to a first temperature, which is a temperature that is less than a melting point of the aluminum and is greater than or equal to a melting point of at least one type of the plastic, so as to melt the at least one type of the plastic, a first container that accommodates the processing target heated by the first heating means to the first temperature, and a first pressing member that has a hole portion allowing the plastic melted by the first heating means to pass through, and that separates the aluminum and the plastic melted by the first heating means by pressing the processing target accommodated in the first container.

In the separation device, the processing target is heated by the first heating means to the first temperature. The first temperature is a temperature that is less than the melting point of aluminum and is greater than or equal to the melting point of at least one type of plastic. Accordingly, the at least one type of plastic, that is, plastic having a melting point that is less than or equal to the first temperature is melted. The processing target in which the at least one type of plastic is melted in this manner is pressed by the first pressing member in a state in which the processing target is accommodated in the first container. At this time, since a hole portion is provided in the first pressing member, the melted plastic passes through this hole portion. Accordingly, aluminum remains on the pressing surface side of the first pressing member, whereas the melted plastic is extracted on the side opposite to the pressing surface of the first pressing member. In this manner, aluminum and melted plastic are separated.

Also, a separation method according to the present invention includes a first heating step of heating a processing target containing aluminum and one or more types of plastic to a first temperature, which is a temperature that is less than a melting point of the aluminum and is greater than or equal to a melting point of at least one type of the plastic, so as to melt the at least one type of the plastic, and a first pressing step of pressing, with a first pressing member having a hole portion allowing the plastic melted in the first heating step to pass through, the processing target accommodated in a first container that accommodates the processing target heated to the first temperature in the first heating step, so as to separate the aluminum and the plastic melted in the first heating step.

In the separation method, the processing target is heated to the first temperature in the first heating step. The first temperature is a temperature that is less than the melting point of aluminum and is greater than or equal to the melting point of at least one type of plastic. Accordingly, the at least one type of plastic, that is, plastic having a melting point that is less than or equal to the first temperature is melted. The processing target in which the at least one type of plastic is melted in this manner is pressed by the first pressing member in the first pressing step in a state in which the processing target is accommodated in the first container. At this time, since a hole portion is provided in the first pressing member, the melted plastic passes through this hole portion. Accordingly, aluminum remains on the pressing surface side of the first pressing member, whereas the melted plastic is extracted on the side opposite to the pressing surface of the first pressing member. In this manner, aluminum and melted plastic are separated.

### Advantageous Effects of Invention

According to the present invention, a separation device and a separation method with which plastic and aluminum can be separated are realized.

### BRIEF DESCRIPTION OF DRAWINGS

FIG. 1 is a configuration diagram showing an embodiment of a separation device according to the present invention.

FIG. 2 is a cross-sectional view showing a separation unit 20 in the separation device of FIG. 1.

FIG. 3 is a plan view showing the separation unit 20 in the separation device of FIG. 1.

FIG. 4 is a cross-sectional view showing a separation unit 40 in the separation device of FIG. 1.

FIG. 5 is a plan view showing the separation unit 40 in the separation device of FIG. 1.

FIG. 6 is a cross-sectional view for illustrating operations of the separation device of FIG. 1.

FIG. 7 is a cross-sectional view for illustrating operations of the separation device of FIG. 1.

FIG. 8 is a cross-sectional view for illustrating operations of the separation device of FIG. 1.

FIG. 9 is a cross-sectional view for illustrating operations of the separation device of FIG. 1.

### DESCRIPTION OF EMBODIMENTS

Hereinafter, an embodiment of the present invention will be described in detail with reference to drawings. Note that in the description of the drawings, like elements are denoted by like reference numerals and redundant descriptions are omitted.

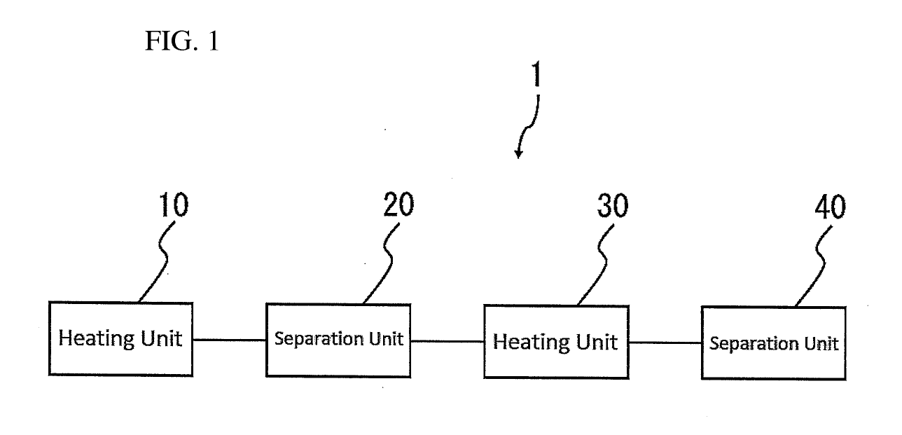

FIG. 1 is a configuration diagram showing an embodiment of a separation device according to the present invention. A separation device 1 is for separating aluminum and plastic by processing a processing target containing aluminum and one or more types of plastic, and extracting plastic from the processing target. The processing target is an aluminized film obtained by vapor-depositing aluminum on plastic, for example. In the present embodiment, the processing target contains three types of plastic, namely, polypropylene (PP), polyethylene (PE), and polyethylene terephthalate (PET).

The separation device 1 includes a heating unit 10, a separation unit 20, a heating unit 30, and a separation unit 40. The heating unit 10 is a heating means (first heating means) for heating the processing target to a first temperature. The first temperature is a temperature that is less than the melting point of aluminum (approximately 660° C.) and is greater than or equal to the melting point of at least one type of plastic. The first temperature is a temperature at which plastic to be separated and extracted does not burn. The first temperature of the present embodiment is 180° C. or greater and 220° C. or less. Melting points of PP, PE, and PET are respectively approximately 180° C., approximately 130° C., and approximately 270° C., and thus the first temperature is a temperature that is greater than or equal to the melting points of PP and PE, and that is less than the melting point of PET. Therefore, among PP, PE, and PET, and aluminum included in the processing target, only PP and PE are melted by being heated to the first temperature. A rotary furnace can be used as the heating unit 10, for example.

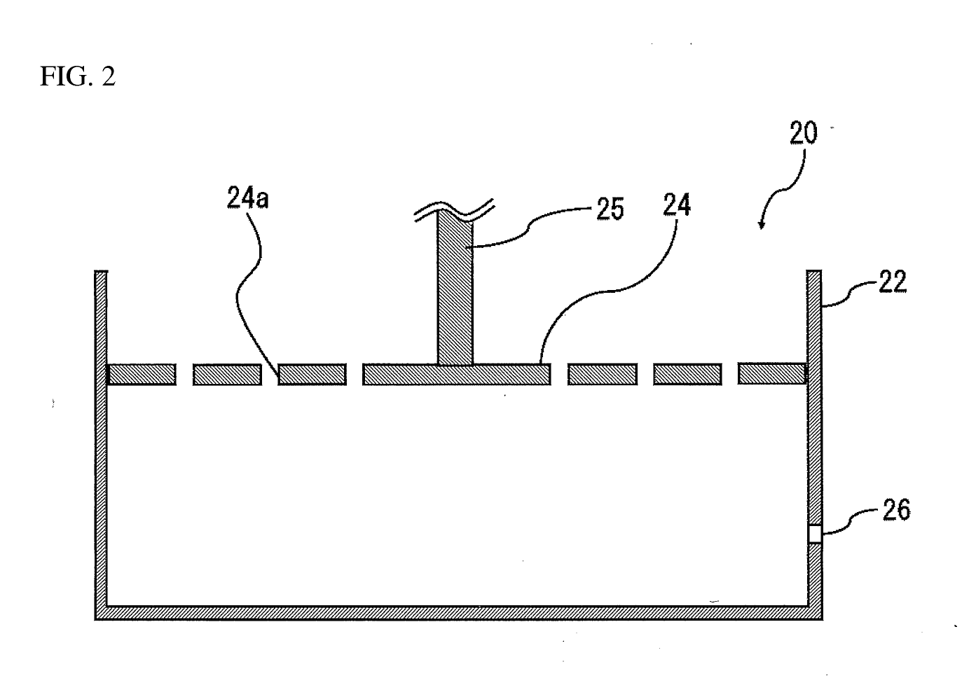

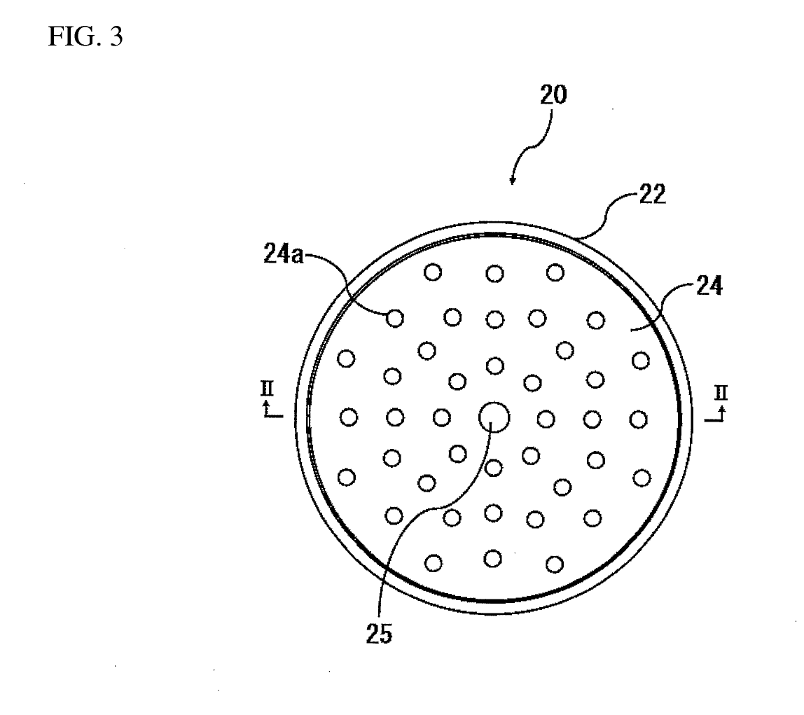

FIG. 2 is a cross-sectional view showing the separation unit 20. Also, FIG. 3 is a plan view showing the separation unit 20. FIG. 2 shows a cross-section taken along line II-II in FIG. 3. The separation unit 20 includes a container 22 (first container) and a pressing member 24 (first pressing member). The container 22 is for accommodating the processing target heated by the heating unit 10 to the first temperature. The container 22 has a heat maintenance function, that is, a function of keeping the processing target accommodated therein at the first temperature. An electric tank (electric furnace) can be used as the container 22, for example.

The pressing member 24 separates aluminum and plastic (PP and PE in the present embodiment) melted by the heating unit 10 by pressing the processing target accommodated in the container 22. Specifically, the pressing member 24 has hole portions 24a, and allows only the melted plastic to pass through the hole portions 24a when pressing the processing target, thereby separating the plastic and aluminum. The hole portions 24a have a size and shape that allow melted plastic to pass through but do not allow unmelted plastic or aluminum to pass through. The shape of the hole portions 24a is circular in plan view in the present embodiment. The hole portions 24a are provided so as to be opened and closed.

As shown in FIG. 3, the container 22 and the pressing member 24 are circular in plan view in the present embodiment. In other words, the container 22 is a container having a cylindrical side surface, and the pressing member 24 is a disk-shaped member. The outer diameter of the pressing member 24 is substantially equal to the inner diameter of the container 22. The pressing member 24 is provided slidably along the inner circumferential surface of the container 22. A shaft portion 25 is attached to the central portion of the pressing member 24. By applying force to the shaft portion 25, the pressing member 24 can be pressed so as to approach the bottom surface of the container 22.

A discharging outlet 26 (first discharging outlet) is provided to penetrate the side surface of the container 22. The discharging outlet 26 is for discharging plastic that has been separated from aluminum by the pressing member 24, that is, for discharging melted plastic to the outside of the container 22. The discharging outlet 26 is provided so as to be opened and closed. The discharging outlet 26 is closed, except for when discharging melted plastic.

Returning to FIG. 1, the heating unit 30 is a heating means (second heating means) for heating the processing target, from which the melted plastic has been separated, to a second temperature. The second temperature is a temperature that is less than the melting point of aluminum (approximately 660° C.) and is greater than or equal to the melting point of at least one type of plastic that has not been melted by the heating unit 10. In the present embodiment, only PET has not been melted by the heating unit 10, and thus the second temperature is greater than or equal to the melting point of PET (approximately 270° C.). The second temperature is a temperature at which plastic to be separated and extracted does not burn. Also, the second temperature is 270° C. or greater and 310° C. or less, for example. Therefore, among the PET and aluminum included in the processing target, only the PET is melted by being heated to the second temperature. A rotary furnace can be used as the heating unit 30, for example.

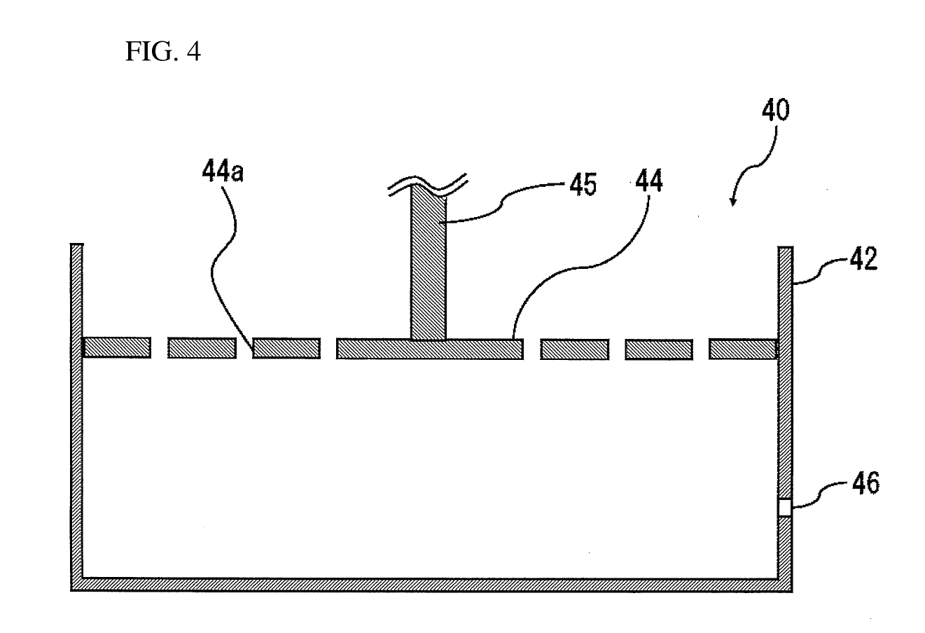

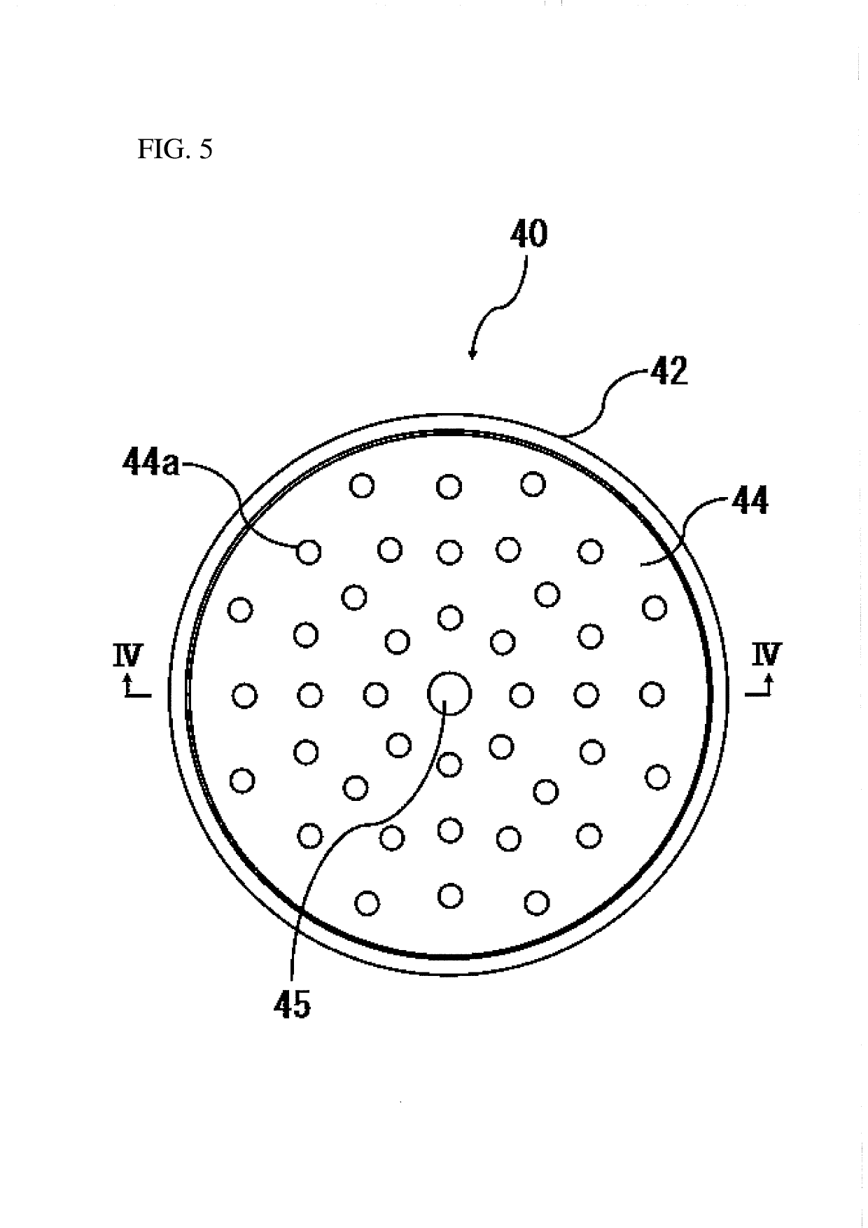

FIG. 4 is a cross-sectional view showing the separation unit 40. Also, FIG. 5 is a plan view showing the separation unit 40. FIG. 4 shows a cross-section taken along line IV-IV in FIG. 5. The separation unit 40 includes a container 42 (second container) and a pressing member 44 (second pressing member). The container 42 is for accommodating the processing target heated by the heating unit 30 to the second temperature. The container 42 has a heat maintenance function, that is, a function of keeping the processing target accommodated therein at the second temperature. An electric tank (electric furnace) can be used as the container 42, for example.

The pressing member 44 separates aluminum and plastic (PET in the present embodiment) melted by the heating unit 30 by pressing the processing target accommodated in the container 42. Specifically, the pressing member 44 has hole portions 44a, and allows only the melted plastic to pass through the hole portions 44a when pressing the processing target, thereby separating the plastic and aluminum. The hole portions 44a have a size and shape that allow melted plastic to pass through but do not allow unmelted plastic or aluminum to pass through. The shape of the hole portions 44a is circular in plan view in the present embodiment. The hole portions 44a are provided so as to be opened and closed.

As shown in FIG. 5, the container 42 and the pressing member 44 are circular in plan view in the present embodiment. In other words, the container 42 is a container having a cylindrical side surface, and the pressing member 44 is a disk-shaped member. The outer diameter of the pressing member 44 is substantially equal to the inner diameter of the container 42. The pressing member 44 is provided slidably along the inner circumferential surface of the container 42. A shaft portion 45 is attached to the central portion of the pressing member 44. By applying force to the shaft portion 45, the pressing member 44 can be pressed so as to approach the bottom surface of the container 42. Note that the container 42 and the pressing member 44 are smaller than the above-described container 22 and the pressing member 24.

A discharging outlet 46 (second discharging outlet) is provided to penetrate the side surface of the container 42. The discharging outlet 46 is for discharging plastic that has been separated from aluminum by the pressing member 44, that is, for discharging melted plastic to the outside of the container 42. The discharging outlet 46 is provided so as to be opened and closed. The discharging outlet 46 is closed, except for when discharging melted plastic.

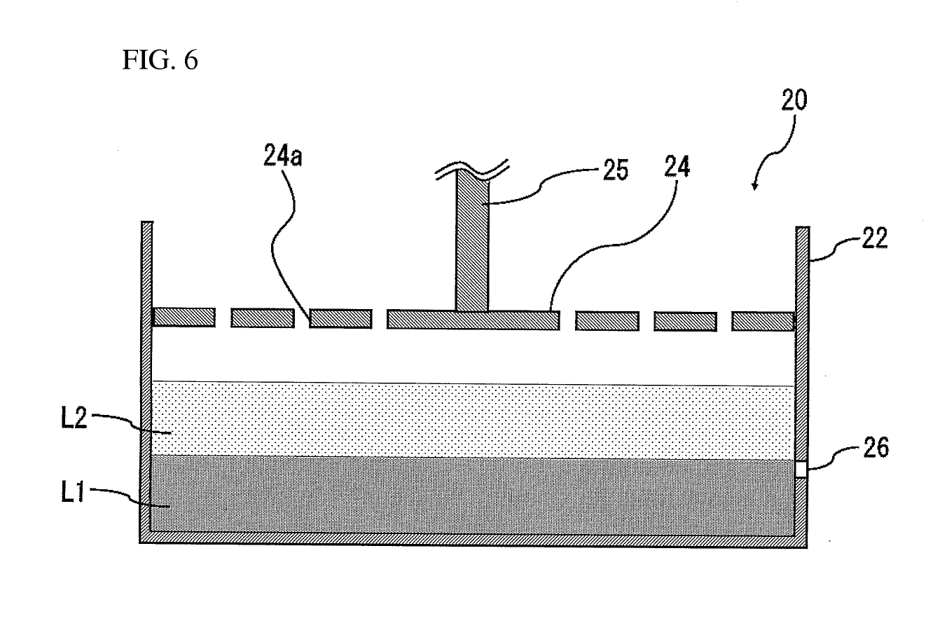

Next, the operations of the separation device 1 will be described as an embodiment of the separation method according to the present invention, with reference to FIGS. 6 to 9. First, the processing target is heated by the heating unit 10 to the first temperature so as to melt PP and PE (a first heating step). The processing target containing melted PP and PE, and unmelted PET and aluminum is transferred to the separation unit 20 by an appropriate means, and is accommodated in the container 22. Thereafter, the processing target is left to stand for a given time (about 2 to 6 hours, for example) while the temperature of the processing target is kept at the first temperature. During this time, the processing target may be stirred. Accordingly, PET and aluminum are precipitated, and as shown in FIG. 6, the processing target is separated into a layer L1 constituted mainly by PET and aluminum and a layer L2 constituted mainly by PP and PE.

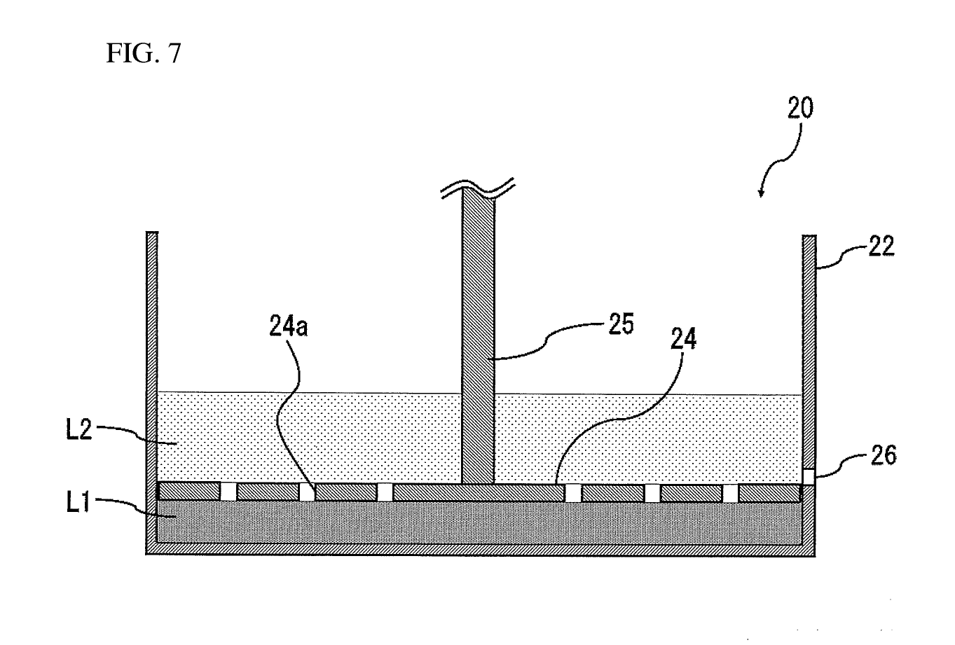

Next, as shown in FIG. 7, the processing target accommodated in the container 22 is pressed by the pressing member 24. At this time, the melted PP and PE pass through the hole portions 24a of the pressing member 24. Accordingly, PET and aluminum remain on the pressing surface side of the pressing member 24, whereas PP and PE are extracted on the opposite side. In this manner, aluminum (and PET, which is unmelted plastic) is separated from PP and PE, which are melted plastic (a first pressing step). Thereafter, in order to prevent PP and PE from returning from the layer L2 to the layer L1 through the hole portions 24a, it is preferable to close the hole portions 24a.

By opening the discharging outlet 26 in this state, PP and PE separated from aluminum are discharged to the outside of the container 22 (first discharging step). Also, the aluminum and PET are discharged to the outside of the container 22 through a discharging outlet (not shown), and are transferred to the heating unit 30. At this time, moisture may be removed from the aluminum and PET by means of dehydration through centrifugation or drying with warm air or the like, as needed.

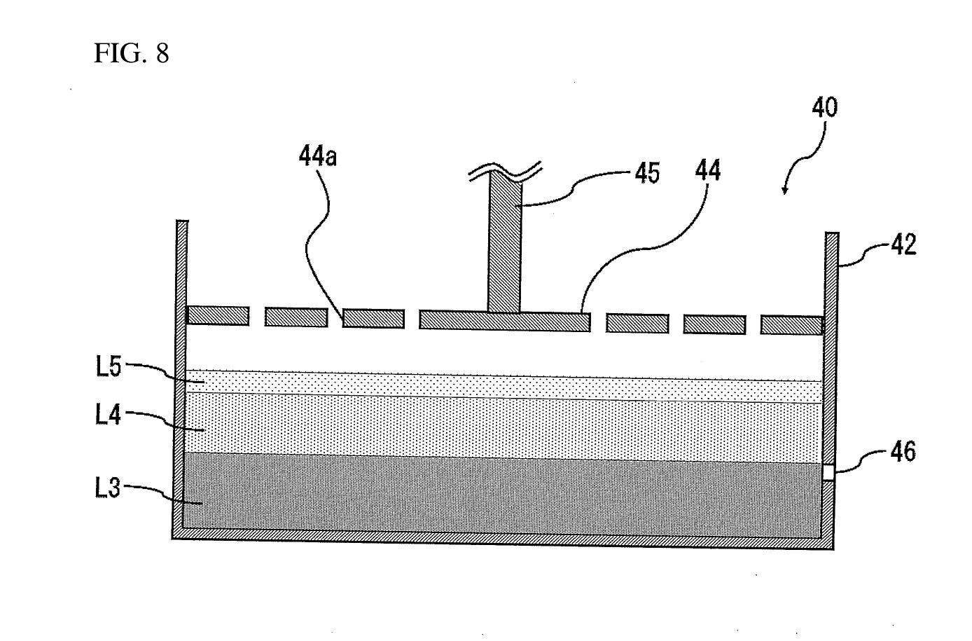

Subsequently, the processing target from which PP and PE have been separated is heated by the heating unit 30 to the second temperature so as to melt the PET (a second heating step). The processing target containing melted PET and unmelted aluminum is transferred to the separation unit 40 by an appropriate means, and is accommodated in the container 42. Thereafter, the processing target is left to stand for a given time (about 2 to 6 hours, for example) while the temperature of the processing target is kept at the second temperature. During this time, the processing target may be stirred. Accordingly, aluminum is precipitated, and as shown in FIG. 8, the processing target is separated into a layer L3 constituted mainly by aluminum and a layer L4 constituted mainly by PET.

Note that although PP and PE that were not separated in the separation unit 20 are present in the container 42, the PP and PE are separated into a layer different from that of PET. Specifically, in contrast to the specific gravity of PET being approximately 1.29 to 1.4, the specific gravity of PP is approximately 0.9, the specific gravity of PE having a high density is approximately 0.95 to 0.97, and the specific gravity of PE having a low density is approximately 0.92 to 0.93, and therefore the processing target is separated into the layer L4 constituted mainly by PET and the layer L5 constituted mainly by PP and PE due to a difference in specific gravity.

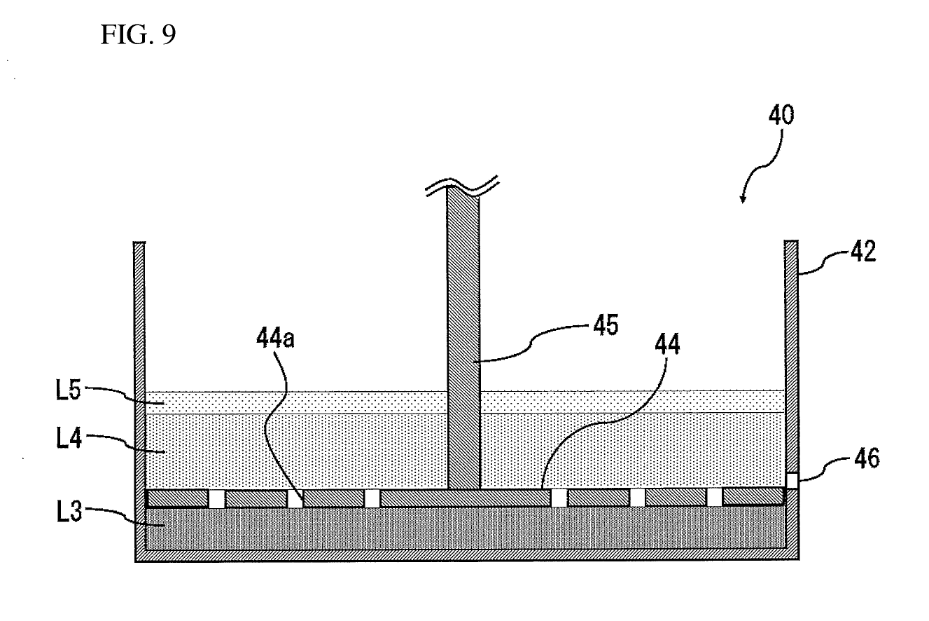

Next, as shown in FIG. 9, the processing target accommodated in the container 42 is pressed by the pressing member 44. At this time, the melted PET (and PP and PE) passes through the hole portions 44a of the pressing member 44. Accordingly, aluminum remains on the pressing surface side of the pressing member 44, whereas PET is extracted on the opposite side. In this manner, aluminum is separated from PET, which is a melted plastic (a second pressing step). Thereafter, in order to prevent PET from returning from the layer L4 to the layer L3 through the hole portions 44a, it is preferable to close the hole portions 44a.

By opening the discharging outlet 46 in this state, PET separated from aluminum is discharged to the outside of the container 42 (second discharging step). Also, the aluminum is discharged to the outside of the container 42 through a discharging outlet (not shown), as needed.

Effects of the present embodiment will be described. In the present embodiment, the processing target is heated by the heating unit 10 to the first temperature. Accordingly, PP and PE, that is, plastic having a melting point that is less than or equal to the first temperature is melted. The processing target in which PP and PE are melted in this manner is pressed by the pressing member 24 in a state in which the processing target is accommodated in the container 22. At this time, since the pressing member 24 are provided with the hole portions 24a, the melted plastic (PP and PE) passes through the hole portions 24a. Accordingly, aluminum (and PET, which is unmelted plastic) remains on the pressing surface side of the pressing member 24, whereas PP and PE are extracted on the opposite side. In this manner, aluminum is separated from PP and PE.

The unmelted plastic (PET) and aluminum are precipitated in the container 22 as described above, and therefore by merely being left to stand for a given time, these can be separated from the melted plastic (PP and PE) to some extent. Regarding this point, in the present embodiment, by pressing the processing target with the pressing member 24, PET and aluminum are concentrated on the pressing surface side of the pressing member 24, and PP and PE are concentrated on the opposite side. Thus, highly-pure PP and PE can be obtained. The obtained PP and PE can be reused as a plastic material. Although PP and PE can be reused as a mixture, if necessary, PP and PE may be separated.

Conventionally, it has been difficult to separate a highly-pure plastic from an aluminized film, but the separation technique according to the present embodiment can be used practically.

Furthermore, the hole portions 24a of the pressing member 24 can be opened and closed. Therefore, by closing the hole portions 24a after the processing target is pressed by the pressing member 24, it is possible to prevent PP and PE from returning to the pressing surface side from the side opposite to the pressing surface.

The pressing member 24 is provided slidably along the inner circumferential surface of the container 22. That is, the pressing surface side of the pressing member 24 and the side opposite thereto are in communication with each other through only the hole portions 24a. Therefore, it is possible to prevent the unmelted plastic and aluminum from moving to the side opposite to the pressing surface of the pressing member 24.

The discharging outlet 26 is provided in the side surface of the container 22. Accordingly, the separated plastic (PP and PE) can be easily brought out from the container 22.

Also, not only the heating unit 10 and the separation unit 20 but also the heating unit 30 and the separation unit 40 are provided in the present embodiment. The processing target is heated by the heating unit 30 to the second temperature. Accordingly, PET, that is, plastic having a melting point that is less than or equal to the second temperature is melted. The processing target in which PET is melted in this manner is pressed by the pressing member 44 in a state in which the processing target is accommodated in the container 24, At this time, since the pressing member 44 is provided with the hole portions 44a, the melted plastic (PET) passes through these hole portions 44a. Accordingly, aluminum remains on the pressing surface side of the pressing member 44, whereas PET is extracted on the opposite side. In this manner, aluminum and PET are separated.

As described above, the unmelted aluminum is precipitated in the container 42, and thus by merely leaving aluminum to stand for a given time, aluminum can be separated from the melted plastic (PET) to some extent. Regarding this point, in the present embodiment, by pressing the processing target with the pressing member 44, aluminum is concentrated on the pressing surface side of the pressing member 44, and PET is concentrated on the opposite side. Therefore, highly-pure PET can be obtained. The obtained PET can be reused as a plastic material. Also, the aluminum separated from the plastic can be reused.

Furthermore, the hole portions 44a of the pressing member 44 can be opened and closed. Therefore, by closing the hole portions 44a after the processing target is pressed by the pressing member 44, it is possible to prevent PET from returning to the pressing surface side from the side opposite to the pressing surface.

The pressing member 44 is provided slidably along the inner circumferential surface of the container 42. That is, the pressing surface side of the pressing member 44 and the side opposite thereto are in communication with each other through only the hole portions 44a. Therefore, it is possible to prevent the unmelted plastic and aluminum from moving to the side opposite to the pressing surface of the pressing member 44.

A discharging outlet 46 is provided in the side surface of the container 42. Accordingly, the separated plastic (PET) can be easily brought out from the container 42.

The separation device and the separation method according to the present invention are not limited to the above-described embodiment, and various modifications can be made thereto. For example, a case where the processing target contains three types of plastic (PP, PE, and PET) has been described in the above-described embodiment. However, it is possible for the processing target to contain only one type of plastic. In such a case, the plastic can be separated by merely performing heating and separation one time each, and thus it is not necessary to provide the heating unit 30 and the separation unit 40.

In general, the processing target may contain n types (n is an integer that is greater than or equal to 2) of plastic. In the case where the first temperature is set to a temperature that is greater than or equal to each melting point of m types (m is an integer that is greater than or equal to 1 and less than n) of plastic, and that is less than each melting point of (n−m) types of plastic, the m types of plastic are melted by the heating unit 10 and are separated from aluminum by the pressing member 24. In this case, the second temperature is a temperature that is less than the melting point of the aluminum and that is greater than or equal to the melting point of at least one of the (n−m) types of plastic. Note that a case of n=3 and m=2 has been described as an example in the above-described embodiment.

In the above-described embodiment, a case in which heating and separation are performed two times has been described. However, heating and separation may be executed three times or more. For example, in the case where the processing target contains three types of plastic that need to be separated and extracted individually, it is sufficient to perform heating and separation three times.

In the above-described embodiment, an example in which one separation unit is provided for one heating unit has been described. That is, in the separation device 1, one separation unit 20 is provided for one heating unit 10, and one separation unit 40 is provided for one heating unit 30. However, a plurality of separation units may be provided for one heating unit. For example, in the separation device 1, a plurality of separation units 20 may be provided for one heating unit 10. Similarly, a plurality of separation units 40 may be provided for one heating unit 30.

In the case where the separation device is operated continuously, usually, the processing time of the separation unit is longer than the processing time of the heating unit, and thus in a configuration in which one separation unit is provided for one heating unit, there is a time span during which the heating unit cannot operate due to waiting for processing performed by the separation unit. That is, if the heating unit is operated continuously, the processing of the separation unit cannot catch up with that of the heating unit, and thus the heating unit needs to be operated intermittently in accordance with the processing time of the separation unit. In contrast, according to the configuration in which a plurality of separation units are provided for one heating unit, it is possible to reduce the time for waiting for the heating unit (the time during which the heating unit cannot operate due to waiting for the processing of the separation units) and to efficiently operate the entire separation device.

In the above-described embodiment, an example was shown in which the heating unit 10 is provided separately from the separation unit 20. However, the heating unit 10 may be provided integrally with the separation unit 20. In other words, the separation unit 20 may include the function of the heating unit 10 as well. The same applies to the heating unit 30 and the separation unit 40.

In the above-described embodiment, hole portions 24a that are circular in plan view have been described as an example. However, the hole portions 24a may have another shape (rectangular shape in plan view, for example). Also, the hole portion 24a may be formed by making substantially the entirety or a portion of the pressing member 24 a net-like shape. In other words, in this case, the meshes of the pressing member 24 correspond to the hole portions 24a. The same applies to the hole portions 44a.

### LIST OF REFERENCE NUMERALS

1 Separation device

10 Heating unit (first heating means)

20 Separation unit

22 Container (first container)

24 Pressing member (first pressing member)

24a Hole portion

25 Shaft portion

26 Discharging outlet (first discharging outlet)

30 Heating unit (second heating means)

40 Separation unit

42 Container (second container)

44 Pressing member (second pressing member)

44a Hole portion

45 Shaft portion

46 Discharging outlet (second discharging outlet)

1. A separation device, comprising:
a first heating means for heating a processing target containing aluminum and one or more types of plastic to a first temperature, which is a temperature that is less than a melting point of the aluminum and is greater than or equal to a melting point of at least one type of the plastic, so as to melt the at least one type of the plastic;
a first container that accommodates the processing target heated by the first heating means to the first temperature; and
a first pressing member that has a hole portion allowing the plastic melted by the first heating means to pass through, and that separates the aluminum and the plastic melted by the first heating means by pressing the processing target accommodated in the first container.

2. The separation device according to claim 1, wherein
the hole portion of the first pressing member can be opened and closed.

3. The separation device according to claim 1, wherein
the first pressing member is provided slidably along an inner circumferential surface of the first container.

4. The separation device according to claim 1, comprising
a first discharging outlet that is provided to penetrate a side surface of the first container, and discharges the plastic that has been melted by the first heating means and has been separated from the aluminum by the first pressing member, to an outside of the first container.

5. The separation device according to claim 1, wherein
a plurality of the first containers and a plurality of the first pressing members are provided for one said first heating means.

6. The separation device according to claim 1, wherein
the processing target contains n types (n is an integer that is greater than or equal to 2) of the plastic,
the first temperature is a temperature that is greater than or equal to each melting point of m types (m is an integer that is greater than or equal to 1 and less than n) of the plastic, and that is less than each melting point of (n−m) types of the plastic, and
the m types of the plastic are melted by the first heating means, and are separated from the aluminum by the first pressing member.

7. The separation device according to claim 6, comprising:
a second heating means for heating the processing target, from which the m types of the plastic have been separated, to a second temperature, which is a temperature that is less than the melting point of the aluminum and is greater than or equal to the melting point of at least one of the (n−m) types of the plastic, so as to melt the at least one type of the plastic;
a second container that accommodates the processing target heated by the second heating means to the second temperature; and
a second pressing member that has a hole portion allowing the plastic melted by the second heating means to pass through, and that separates the aluminum and the plastic melted by the second heating means by pressing the processing target accommodated in the second container.

8. The separation device according to claim 7, wherein
the hole portion of the second pressing member can be opened and closed.

9. The separation device according to claim 7, wherein
the second pressing member is provided slidably along an inner circumferential surface of the second container.

10. The separation device according to claim 7, comprising
a second discharging outlet that is provided to penetrate a side surface of the second container, and discharges the plastic that has been melted by the second heating means and has been separated from the aluminum by the second pressing member, to an outside of the second container.

11. The separation device according to claim 1, wherein
the processing target contains polypropylene, polyethylene, and polyethylene terephthalate as the plastic.

12. The separation device according to claim 1, wherein
the processing target is an aluminized film obtained by vapor-depositing the aluminum on the plastic.

13. A separation method, comprising:
a first heating step of heating a processing target containing aluminum and one or more types of plastic to a first temperature, which is a temperature that is less than a melting point of the aluminum and is greater than or equal to a melting point of at least one type of the plastic, so as to melt the at least one type of the plastic; and
a first pressing step of pressing, with a first pressing member having a hole portion allowing the plastic melted in the first heating step to pass through, the processing target accommodated in a first container that accommodates the processing target heated to the first temperature in the first heating step, so as to separate the aluminum and the plastic melted in the first heating step.

14. The separation method according to claim 13, wherein
the hole portion of the first pressing member can be opened and closed.

15. The separation method according to claim 13, wherein
the first pressing member is provided slidably along an inner circumferential surface of the first container.

16. The separation method according to claim 13, comprising
a first discharging step of discharging the plastic that has been melted in the first heating step and has been separated from the aluminum in the first pressing step, through a first discharging outlet provided to penetrate a side surface of the first container, to an outside of the first container.

17. The separation method according to claim 13, wherein
the processing target contains n types (n is an integer that is greater than or equal to 2) of the plastic,
the first temperature is a temperature that is greater than or equal to each melting point of m types (m is an integer that is greater than or equal to 1 and less than n) of the plastic, and that is less than each melting point of (n−m) types of the plastic, and
the m types of the plastic are melted in the first heating step, and are separated from the aluminum in the first pressing step.

18. The separation method according to claim 17, comprising:
a second heating step of heating the processing target, from which the m types of the plastic have been separated, to a second temperature, which is a temperature that is less than the melting point of the aluminum and is greater than or equal to the melting point of at least one of the (n−m) types of the plastic, so as to melt the at least one type of the plastic; and
a second pressing step of pressing, with a second pressing member having a hole portion allowing the plastic melted in the second heating step to pass through, the processing target accommodated in a second container that accommodates the processing target heated to the second temperature in the second heating step, so as to separate the aluminum and the plastic melted in the second heating step.

19. The separation method according to claim 13, wherein
the processing target contains polypropylene, polyethylene, and polyethylene terephthalate as the plastic.

20. The separation method according to claim 13, wherein
the processing target is an aluminized film obtained by vapor-depositing the aluminum on the plastic.
